(19) United States
(12) Patent Application Publication
(10) Pub. No.: US 2015/0269863 A1
(43) Pub. Date: Sep. 24, 2015

(54) Method, Device, and System for Teaching Cursive Writing

(71) Applicant: Linda Fray Shrewsbury, Tulsa, OK (US)

(72) Inventor: Linda Fray Shrewsbury, Tulsa, OK (US)

(21) Appl. No.: 14/247,152

(22) Filed: Apr. 7, 2014

Related U.S. Application Data
(60) Provisional application No. 61/956,093, filed on Jun. 3, 2013.

(51) Int. Cl. G09B 11/00

(52) U.S. Cl. CPC G09B 11/00

(57) ABSTRACT

The following invention is a method for teaching cursive writing to students quickly and effectively through grouping of letters with common basic shapes into letter strings that may be written by the student in a continuous movement, without lifting the pen.

The system was developed out of seeking an abbreviated way of teaching cursive penmanship to a learning disabled student. After several days of focusing on lowercase cursive letters I had written on a white board, a pattern I had never noticed before became evident. Based on my observations, I divided the letters into four categories and wondered if pointing out the pattern to my student would be helpful. I hoped the task of learning variations on four basic shapes would seem less overwhelming than the chore of practicing 26 discreet letter forms one by one.

### WRITTEN DESCRIPTION OF INVENTION

This application claims priority to provisional application 61/956,093 filed on Jun. 3, 2013, the entirety of which is incorporated by reference herein. A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

The application relates to the art of handwriting education. Handwriting is a subject that is underemphasized in the modern education system, particularly cursive writing. One of the reasons is that it can be viewed as time consuming. A method for shortening the time that is required to teach students the skills necessary for cursive writing is desirable.

Teaching of handwriting and writing skills traditionally occupied a great deal of the time of primary, preprimary and grade school teachers. The methods varied but usually involved the teachers presentation of the desired form of a symbol, letter, and the like, the students attempt at faithfully copying or reproducing the symbol, the teachers correction of that attempt, the students observation of his errors and their correction, and a repetition of the process until the student is able to reproduce the symbol correctly from memory. Correctly could mean that the student's representation is sufficiently precise as to be meaningful to another person who has knowledge of the correct form of the symbol which is to be communicated.

Communication through writing, however, is richer in nature than sender simply sending a message to a receiver that has meaning. The way a person expresses herself through writing tells the reader more than the information the writer intended to convey through the words. Generally neat penmanship with the flourishes of cursive writing reflects positively on the writer. Additionally, the learning of cursive writing was and continues to be a source of pride and accomplishment for the students of all age who master it.

Additionally, hand-writing, which is rapidly declining due to the advent of digital media, has been shown to better suited to learning environments than typing. In Digitizing Literacy: Reflections on the Haptics of Writing by Anne Mangen and Jean-Luc Velay, it is stated that “writing is a highly sophisticated and comprehensive way of externalizing our thoughts.” Mangen and Velay conclude that “. . . the decoupling of motor input and haptic and visual output enforced by the computer keyboard as a writing device . . .” is ill advised for more effective learning from a neuroscience perspective.

In spite of scientific confirmation of the benefits of hand writing in education, its emphasis in that field is on the decline. Writers from sources The Washington Post, California Teachers Association, The New York Times, and ABC News have written about the disappearance of cursive writing from primary education, its traditional place of instruction. It could be presumed that one of the driving forces behind this disappearance is the time required to teach cursive writing. Standardized tests have emerged as the primary means by which public schools and their system are judged and spending significant amounts of time on subjects like cursive writing, which have little or no direct bearing on standardized testing will invariably seem less important.

Given the importance of handwriting to the foundational principles of education, that of giving a student the basics needed for higher education and for life, it is desirable that a means be found for minimizing the time required to teach students cursive writing. Given the plurality of digital technologies for human input into digital devices, it is also desirable to find ways to integrate education in cursive writing with said devices in a way that does not deprive students of the benefits of traditional cursive writing.

### SUMMARY OF INVENTION

This invention is a system, device, and method used independently or in conjunction with one another for teaching the fundamentals of cursive writing in a reduced amount of time over previous teaching methods. To accomplish this end, the letters of an alphabet are broken into four basic shapes. The four shapes are components of which the cursive letters are comprised. For the purposes of this application, the component shapes are referred to an oval, a loop, a swing, and a mound.

The basic exercise for “Oval Letters” consists of the student making the letters “acdgqo” in one connected stroke. The basic exercise for “Loop Letters” consists of the student making the letters “fhkleb” in one connected stroke. The basic exercise for “Swing Letters” consists of the student making the letters “ijprstuw” in one connected stroke. The basic exercise for “Mound Letters” consists of the student making the letters “mnxyzv” in one connected stroke.

The performance of these exercises where the primary stroke is the same for each letter and the letters are written in one composite stroke in which the writing utensil is never lifted from the writing surface, reinforces in the mind of the student the groupings of the letters. Teaching the letters by connecting them in the mind of a student with a common stroke, then having the student perform exercises forming all the letters containing that stroke together, enables quick mastery.

While there are many primers on handwriting instruction, the inventor created these groupings with the goal of helping a developmentally disabled student who expressed an interest in learning to write his own name in cursive. The groupings assisted him learning to do so in a minimum amount of time. The result of the repeating, of the entire alphabet in four easy strokes yielded the unexpected result that the student was able to learn the entire cursive alphabet in less than one hour. There is no handwriting primer, of which the Applicant is aware, on the market that utilizes writing cursive letters in the sequences disclosed herein, and no method that purports to teach, cursive writing in such a short amount of time.

This method of writing instruction may be conveyed through text books, audio visual recordings and person to person instruction (such as classroom instruction and tutoring). These exercises may be carried out with as little as a pencil and paper or a chalkboard but modern touch screen computers provide the ability to integrate instruction for optimal learning. In the preferred embodiment of this method, a touch screen computer with a writing instrument is utilized so that students may view instruction for the method and animations of the exercises. After viewing this material, students may perform the exercises on the touch screen and receive audio and visual feedback during and after the exercises.

### BRIEF DESCRIPTION OF DRAWINGS

FIG. 1 Illustration of the four basic shapes and grouping of the lower-case cursive letters that utilize said shapes.

FIG. 2 The letters based upon the oval stroke.

FIG. 3 The letters based upon the loop stroke.

FIG. 4 The letters based on the swing stroke.

FIG. 5 The letters based upon the mound stroke

FIG. 6 Illustration of method of connecting cursive letters to the letter ‘o’ based upon the four strokes groupings of the invention.

FIG. 7 Illustration of method of connecting cursive letters to the letter ‘b’ based upon the four strokes groupings of the invention.

FIG. 8 Illustration of method of connecting cursive letters to the letter ‘w’ based upon the four strokes groupings of the invention.

FIG. 9 Illustration of method of connecting cursive letters to the letter ‘v’ based upon the four strokes groupings of the invention.

FIG. 10 Grouping of the Capital letters by starting place or starting stroke.

FIG. 11 Illustration of the “Oval Letters” grouping and associated basic exercise.

FIG. 12 The “Oval Letters” advanced exercise comprised of complete language words that are comprised of only the “Oval Letters,” lowercase AC D G Q and O.

FIG. 13 Illustration of the “Loop Letters” grouping and associated basic exercise.

FIG. 14 The “Loop Letters” advanced exercise comprised of complete language words that are comprised of only the “Loop Letters,” lowercase F H K L E and B.

FIG. 15 Illustration of the “Swing Letters” grouping and associated basic exercise.

FIG. 16 The “Swing Letters” advanced exercise comprised of complete language words that are comprised of only the “Swing Letters,” lowercase I J P R S T U and W.

FIG. 17 Illustration of the “Swing Letters” grouping and associated basic exercise.

FIG. 18 The “Swing Letters” advanced exercise comprised of complete language words that are comprised of only the “Swing Letters,” lowercase M N X Y Z and V.

### DETAILED DESCRIPTION

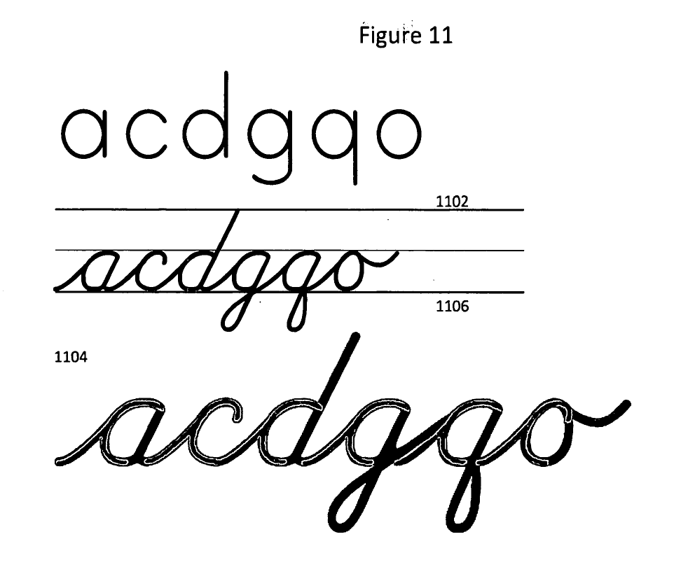

This invention, referred to as Cursive Logic, has three primary embodiments. The first embodiment is the method of using four shapes an oval, a loop, a swing, and a mound, as illustrated in the attached materials. This is an educational method for teaching the construction of all 26 lowercase cursive letters of the English alphabet through combinations of these letters grouped by a main shape feature in each letter in the aforementioned shapes. These elements are illustrated in detail in the following paragraphs. This method is also detailed in the attached FIGS. 11 to 18.

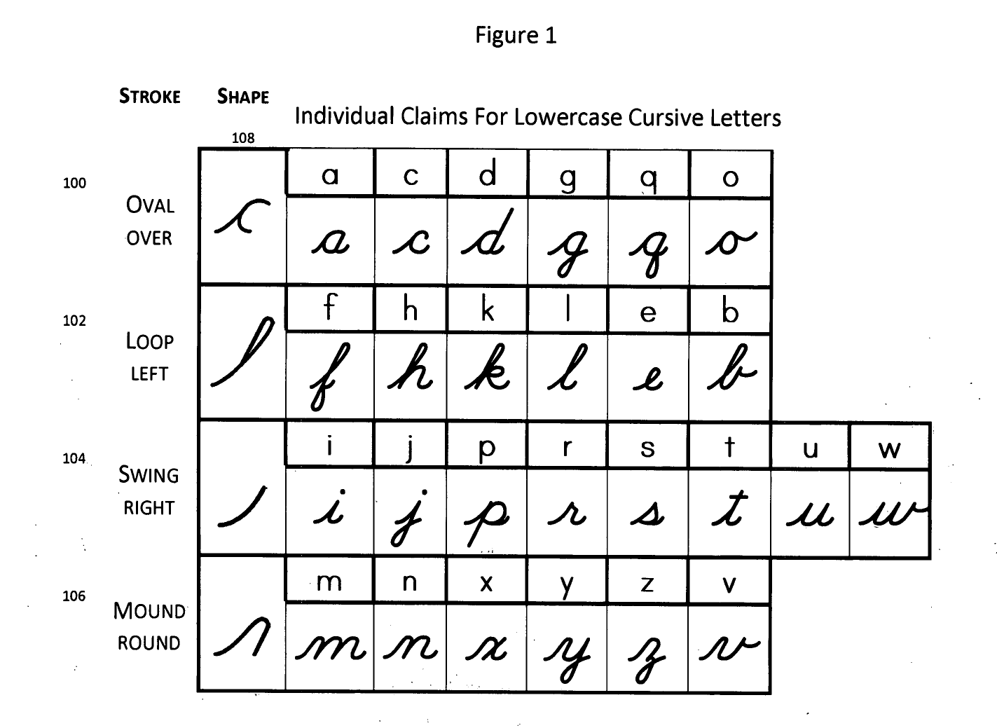

Teaching lower-case cursive letters: Each lowercase cursive letter has a beginning stroke that of is one of four distinct shapes: Oval, Loop, Swing, and Mound (See FIG. 1.)

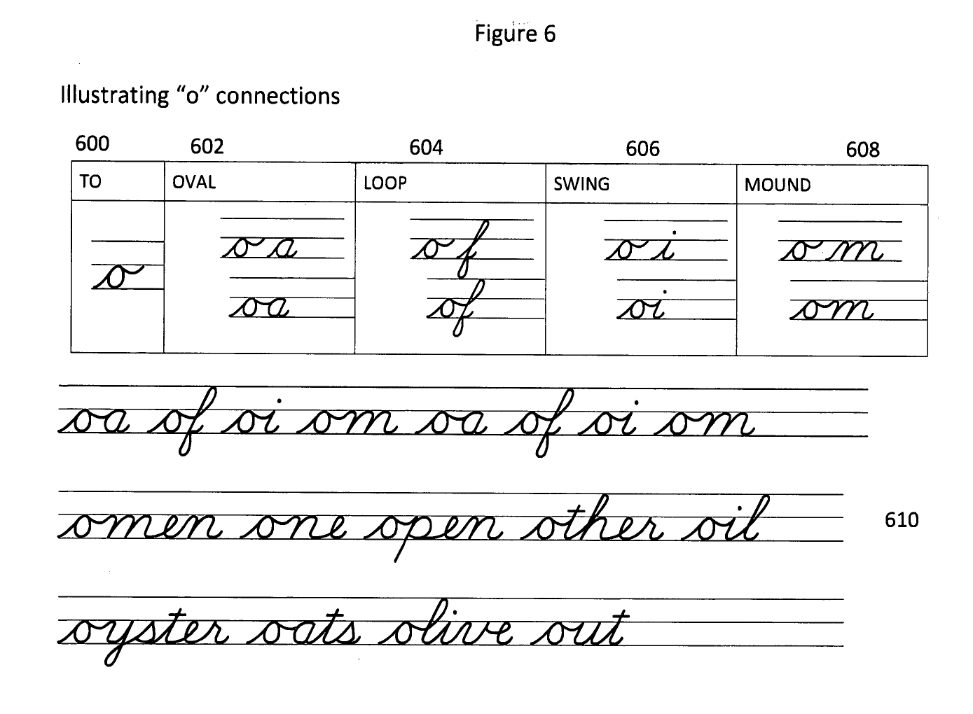

Every lowercase cursive letter begins on the baseline. (The exception “when oval letters begin a word” will be discussed later. Twenty-two letters end with an up-slide that first touches or crosses the baseline. Four letters o b w v (see FIGS. 6 to 9.) end with a curved dip close to the midline that connects with other letters near the mid line. Dips perform the important job of distinguishing a letter from another letter or letter combination. Most cursive letters are similar to print counterparts. [F] r s z and perhaps b are dissimilar. Nevertheless, within their respective shape group, these letters are easily formed.

The second embodiment is a device. Stencils may be created utilizing both the component shapes and the groupings of letters that contain one of the four shapes by that shape, so as emphasize the teaching of that particular component.

The third embodiment is a computer system consisting of a hardware interface and a piece of software for utilizing the claimed method. Many computer systems have touch screens and other means of direct user contact with an input device designed to mimic a classic writing utensil such as a pen or pencil. Though the method above could be utilized with pen and paper, an interactive system would be more effective for teaching the method. Given the ubiquitous nature of mobile computing platforms, the majority of which have touch screen input, the teaching of this unique method could ideally be accomplished by a program or app that may be downloaded into the common mobile computing platforms such as IOS, Android, Windows 8, and Blackberry.

The system may include the use of animated examples of the construction of letters using the method, opportunities to interact with the system by tracing or drawing the letters, auditory instruction, performance metrics, and other elements as needed to emphasize the underlying method of teaching cursive writing to the system user.

### PREFERRED EMBODIMENT OF THE INVENTION

In the preferred embodiment of the invention, a touch sensitive display surface is utilized with or without a writing instrument. A graphical user interface is presented via a non-transitory computer readable medium containing instructions including the Cursive Logic software. The GUI will present a series of exercises as described in the figures

FIG. 1 illustrates the entire English alphabet, lowercase cursive letters, grouped in rows according to the novel categories of this invention. Oval letters ‘acdgqo’ are represented in 100. Loop letters ‘fhkleb’ are represented in the next row 102. The swing letters ‘ijprstuw’ are represented in row 104. The mound letters ‘mnxyzv’ are represented in row 106. Column 108 illustrates basic stroke that is used to create each of the letters in the grouping.

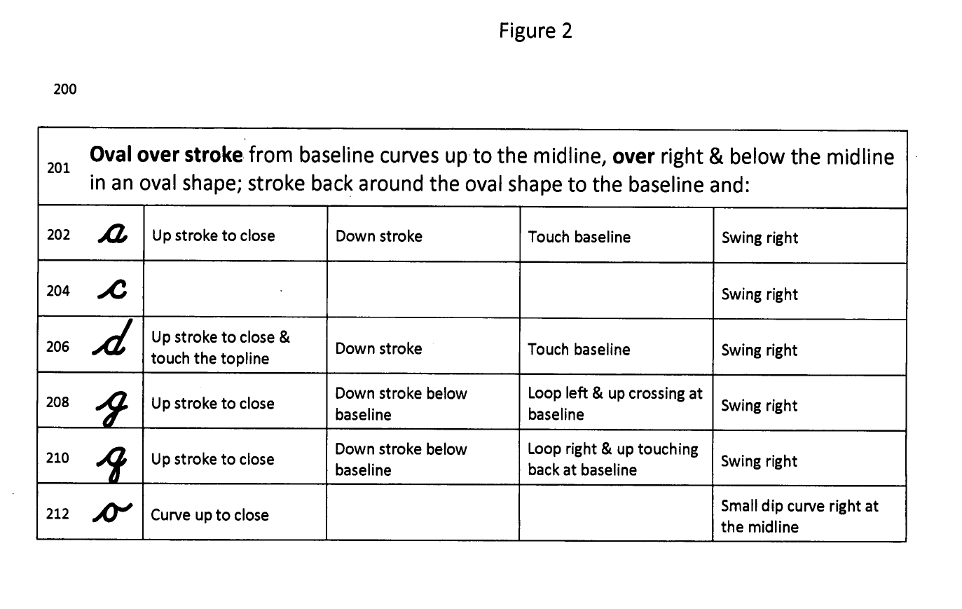

FIG. 2, Item 200 is a chart where each row presents an Oval stroke letter as described in item 100, and the columns describe the strokes, in addition to Oval stroke 201, required by a writing instrument to complete each letter. Row 202 represents the strokes after the initial Oval for creating the letter ‘a’: up stroke to close; down stroke; touch baseline; swing right. Row 204 represents the stroke after the initial Oval for creating the letter ‘c’: swing right. Row 206 represents the strokes after the initial Oval for creating letter ‘d’: up stroke to close & touch top line; down stroke; touch baseline; swing right. Row 208 represents the strokes after the initial Oval for creating the letter ‘g’: up stroke to close; down stroke below baseline; loop left and up crossing at the baseline; swing right. Row 210 represents the strokes after the initial Oval for creating the letter ‘q’: up stroke to close; down stroke below baseline; loop left and up crossing at baseline; swing right. Row 212 represents the strokes after the initial Oval for creating the letter ‘o’: curve up to close; make a small dip at the midline.

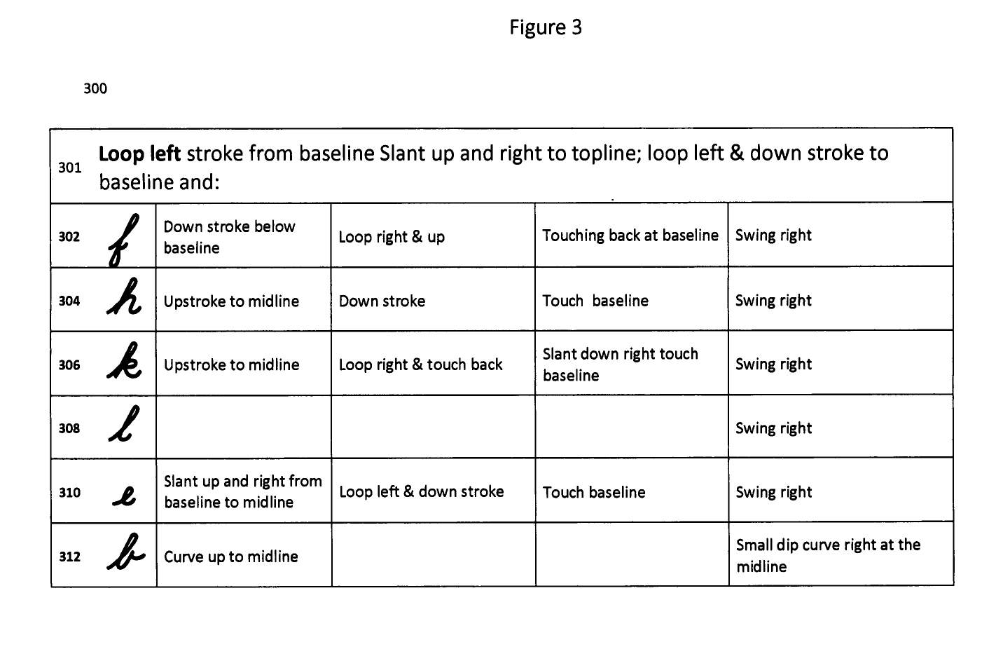

In FIG. 3. Item 300 is a chart where each row represents a Loop stroke letter as described in item 102, and the columns represent the strokes, in addition to the Loop stroke 301. Row 302 represents the strokes after the initial Loop for creating the letter ‘f: down stroke to baseline; loop right and up; touching back at baseline; swing right. Row304 represents the strokes after the initial Loop for creating the letter ‘h’: up stroke to midline; down stroke; touch baseline; swing right. Row 306 represents the stroke after the initial Loop for creating the letter ‘k’: upstroke to midline; loop right and touch back; slant down right touch baseline; swing right. Row 308 represents the strokes after the initial Loop for creating the letter ‘l’: swing right. Row 310 represents the strokes comprising the shorter modified Loop that constructs the letter ‘e’: Slant up and right from baseline to midline; Loop left and down; touch baseline; swing right. Row 312 represents the strokes after the initial Loop for creating the letter ‘b’: curve to midline; make small dip curve at midline.

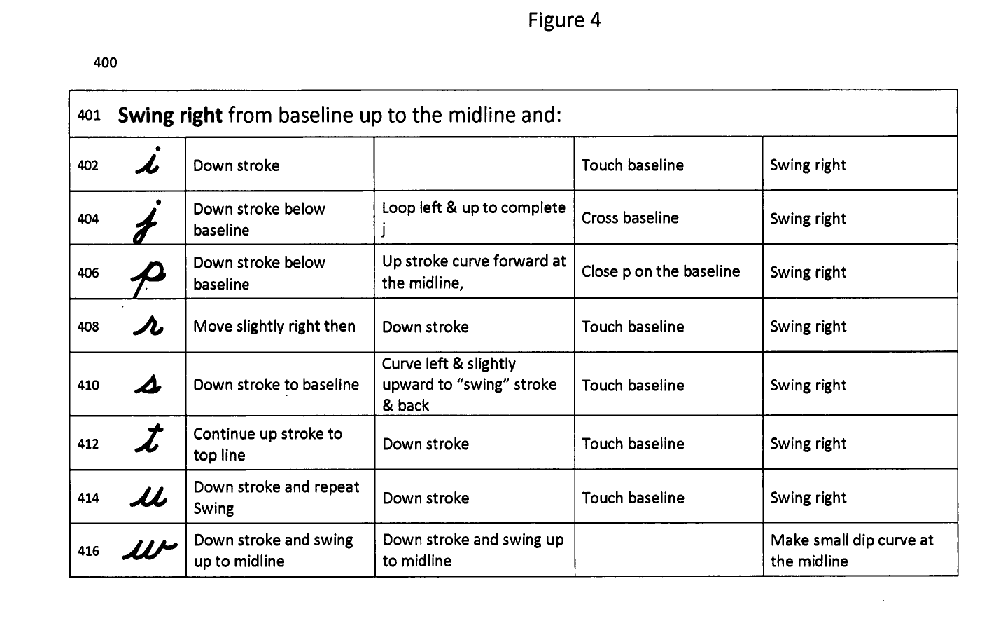

In FIG. 4. Item 400 is a chart where each row represents an Swing Right stroke letter as described in item 104, and the columns represent the strokes, in addition to the Loop stroke 401. Row 402 represents the strokes after the initial Swing for creating the letter ‘i’: down stroke; touch baseline; swing right. Row 404 represents the strokes after the initial Swing for creating the letter down stroke below baseline; loop left and up to complete j; cross baseline; swing right. Row 406 represents the stroke after the initial Swing for creating the letter ‘p’: down stroke below baseline; up stroke curve forward at the midline; close ‘p’ on the baseline; swing right. Row 408 represents the strokes after the initial Swing for creating the letter ‘r’: move slightly right; down stroke; touch baseline; swing right. Row 410 represents the strokes after the initial Swing for creating the letter ‘s’: down stroke to baseline; curve left and slightly upward to “swing” stroke and back; touch baseline; swing right. Row 412 represents the strokes after the initial Swing for creating the letter ‘t’: continue up stroke to top line; down stroke; touch baseline; swing right. Row 414 represents the strokes after the initial Swing for creating the letter ‘u’: down stroke and repeat Swing; down stroke; touch baseline; swing right Row 416 represents the strokes after the initial Swing for creating the letter ‘w’: down stroke and repeat Swing twice; make small dip curve at midline.

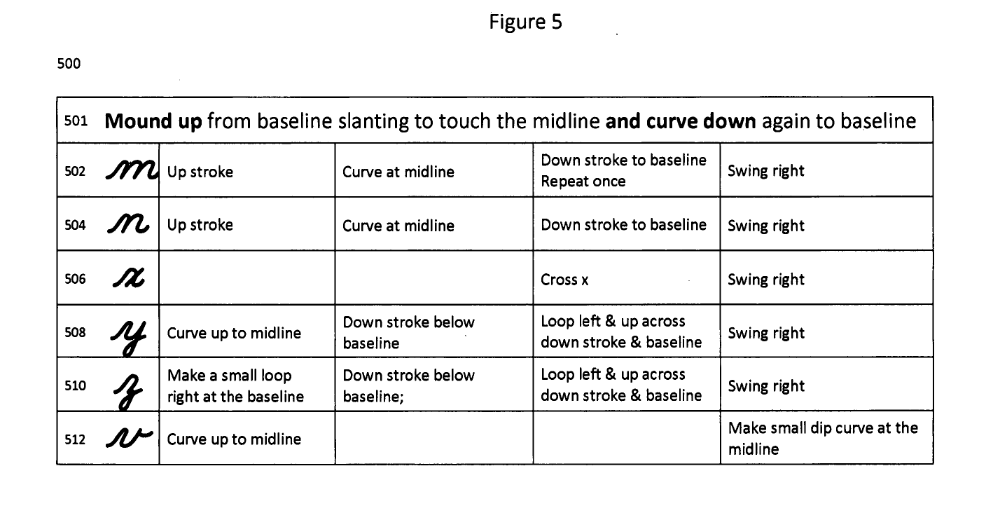

In FIG. 5. Item 500 represents a chart where each row represents a Mound (up) stroke letter as described in item 106, and the columns represent the strokes, in addition to the Mound stroke 501. Row 502 represents the strokes after the initial Mound for creating the letter ‘m’: up stroke; curve at midline; down stroke to baseline repeat once; swing right. Row 504 represents the strokes after the initial Mound for creating the letter ‘n’: up stroke; curve at midline; down stroke to baseline; swing right. Row 506 represents the stroke after the initial Mound for creating the letter ‘x’: cross x; touch baseline; swing right. Row 508 represents the strokes after the initial Mound for creating the letter ‘y’: curve up to midline; down stroke to baseline; loop left and up across down stroke and baseline; swing right. Row 510 represents the strokes after the initial Swing for creating the letter ‘z’: down stroke to baseline; cure let and slightly upward to “sing” stroke and back; touch baseline; swing right. Row 512 represents the strokes after the initial Swing for creating the letter ‘v’: curve up to midline; make small dip curve at midline.

In FIG. 6, item 600 illustrates an example of a lesson or exercise in connecting the four letters ending on the midline with a dip curve (lower-case ‘o’ in this illustration) to each of the four basic groupings of cursive letters. In items 602, 604, 606, and 608 respectively the means of connecting letter “o” to another Oval letter, a Loop letter, a Swing letter, and a Mound letter. Item 610 illustrates various handwriting exercises with letter groupings and English words that present the opportunity to perform the connections between the letter group types as illustrated in 602-608.

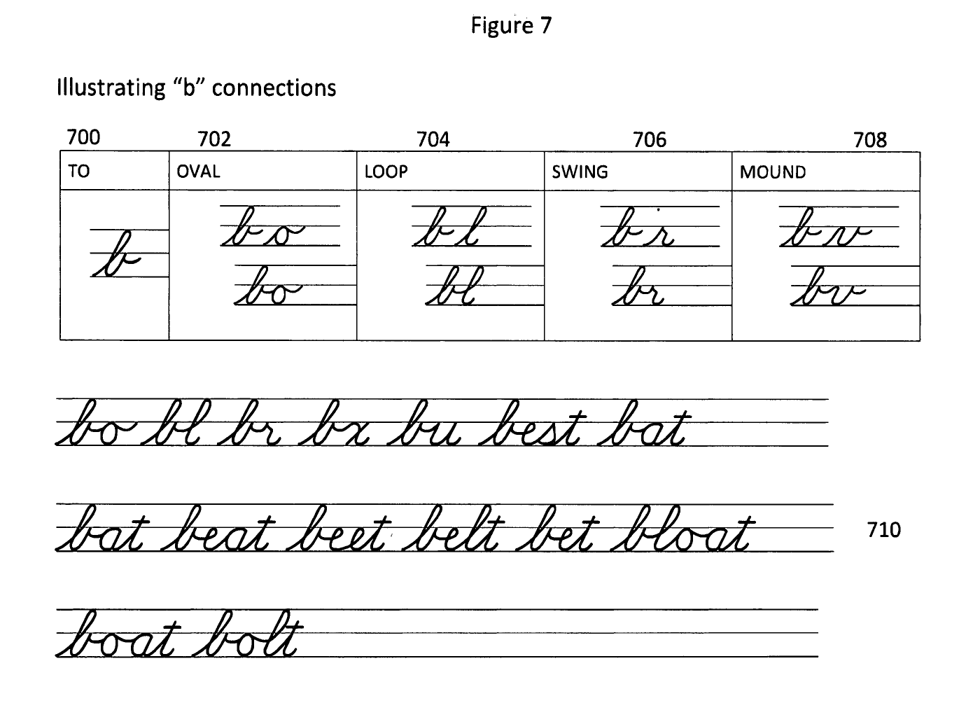

In FIG. 7, item 700 illustrates an example of a lesson or exercise in connecting the midline-ending letter lower-case ‘b’ to each of the four basic groupings of cursive letters. In items 702, 704, 706, and 708 respectively the means of connecting a ‘Loop’ letter to an Oval letter, another Loop letter, a Swing letter, and a Mound letter. Item 710 illustrates various handwriting exercises with letter groupings and English words that present the opportunity to perform the connections between the letter group types as illustrated in 702-708.

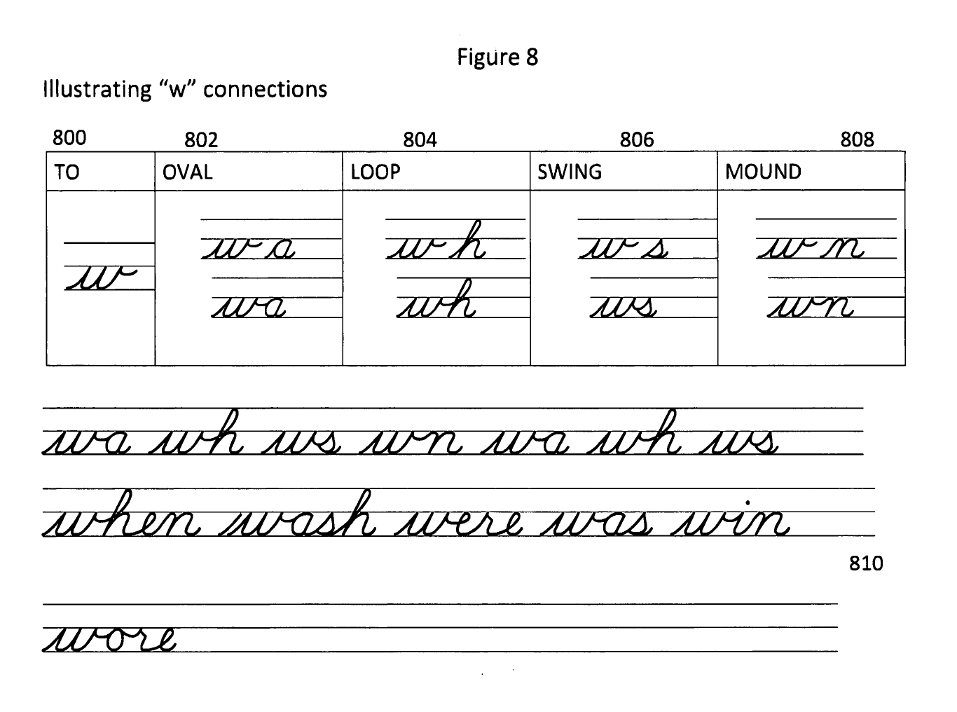

In FIG. 8, item 800 illustrates an example of a lesson or exercise in connecting the midline-ending letter lower-case ‘w’ to each of the four basic groupings of cursive letters. Items 802, 804, 806, and 808 respectively illustrate connecting letter “w” to an Oval letter, a Loop letter, another Swing letter, and a Mound letter. Item 810 illustrates various handwriting exercises with letter groupings and English words that present the opportunity to perform the connections between the letter group types as illustrated in 802-808.

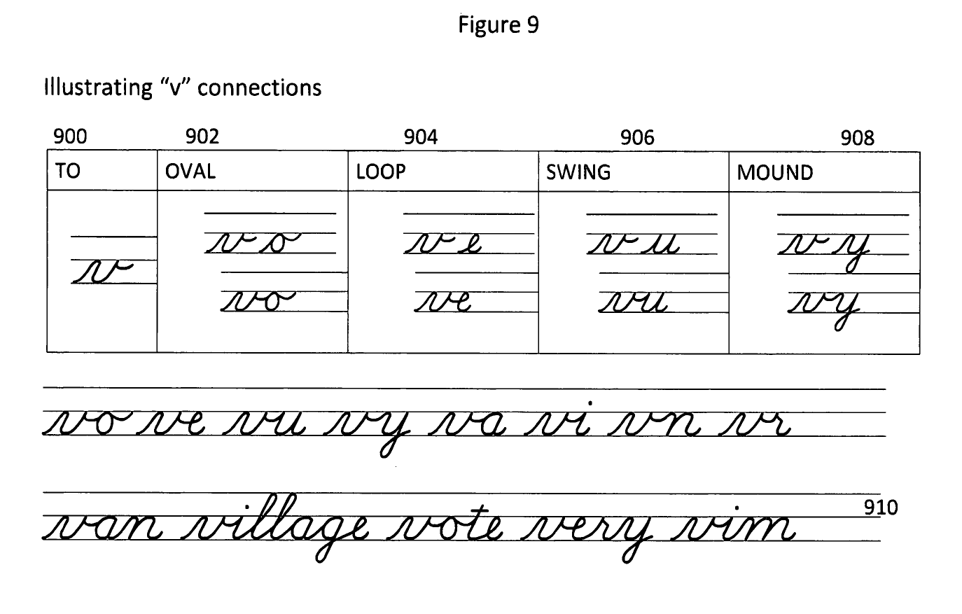

In FIG. 9, item 900 illustrates an example of a lesson or exercise in connecting midline-ending lower-case ‘v’ to each of the four basic groupings of cursive letters. In items 902, 904, 906, and 908 respectively illustrate the means of connecting letter “v” to an Oval letter, a Loop letter, a Swing letter, and another Mound letter. Item 910 illustrates various handwriting exercises with letter groupings and English words that present the opportunity to perform the connections between the letter group types as illustrated in 902-908.

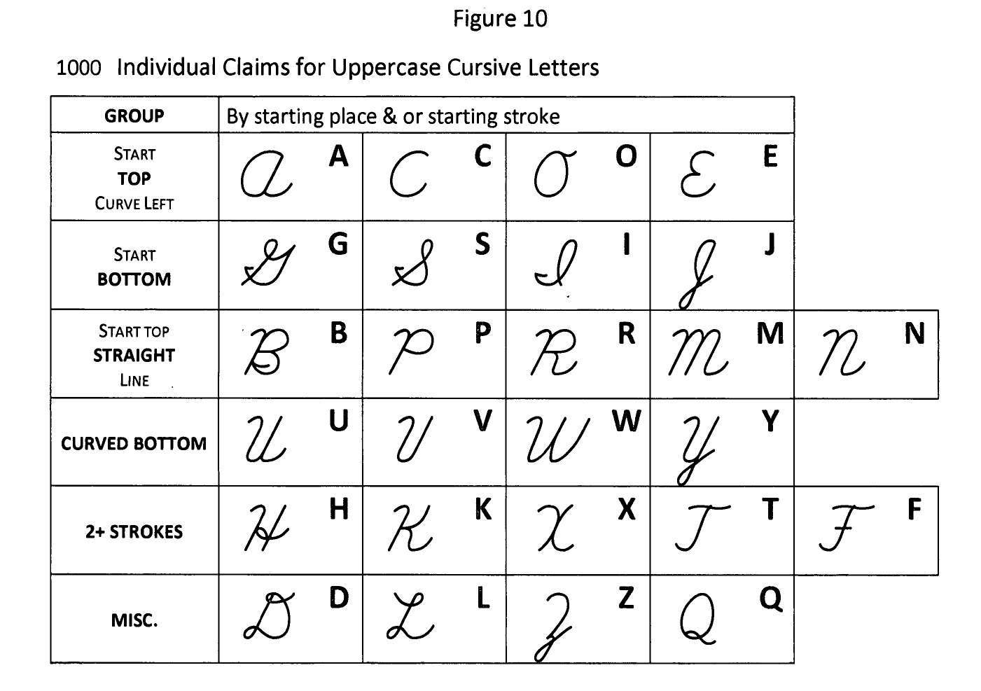

In FIG. 10, illustrated are the capital letters in the cursive alphabet grouped into categories based upon the starting place or starting stroke in the construction of the letters. Letters ‘A,’ ‘C,’ ‘O,’ and ‘E’ are grouped because they all start at the top line and curve left. Letters G, S, L and J are grouped because they all begin on the bottom line. Letters B, P, R, M, N are grouped because they all begin with a ‘Straight stroke’ from the top line and moves straight down to the bottom line with the appropriate right slant. Letter U, V, W, and Y are grouped because all have a curved bottom. Letters H, K, X, T and F are grouped because the each require two separate strokes. Letters D L Z and Q are grouped because they have unique qualities and are categorized as miscellaneous. The grouping of the capital letters, by the specific features outlined above, minimizes the time required by a student to learn the upper-case cursive alphabet by emphasizing letters with fundamentally similar qualities.

In FIG. 11 illustrates one of the main exercises of the preferred embodiment of the invention which combines the Oval letters in a grouping. The grouping of letters is designed to be the preferred embodiment where all the letters can be made in a single stroke without lifting the pen or electronic writing instrument.

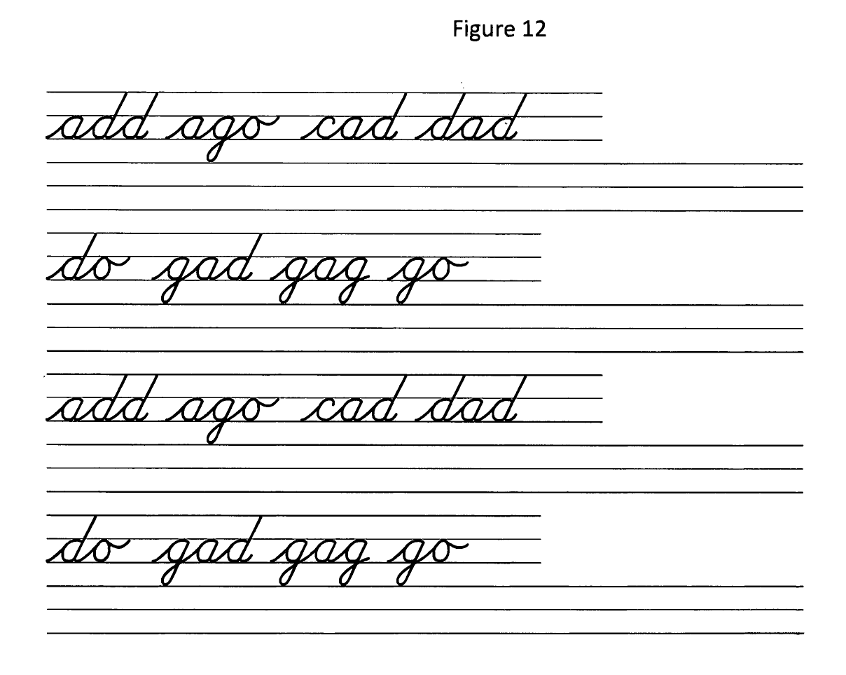

In FIG. 12, illustrated is a handwriting exercise consisting of words that can be formed using only the Oval letters.

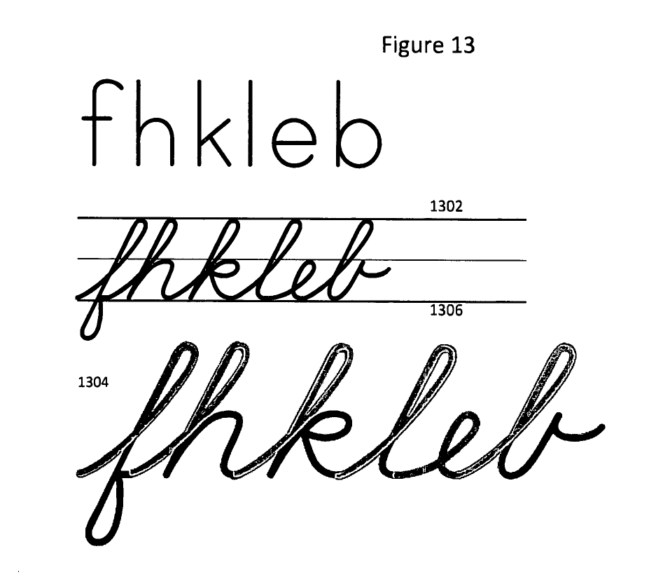

In FIG. 13, illustrated is one of the main exercises of the preferred embodiment of the invention which combines the Loop letters in a grouping. The grouping of the letters is designed to be the preferred embodiment where all the letters can be made in a single stroke without lifting the pen or electronic writing instrument. Item 1304 illustrates the portion of each letter that is not a loop in darker coloring and the part that is a loop in lighter coloring.

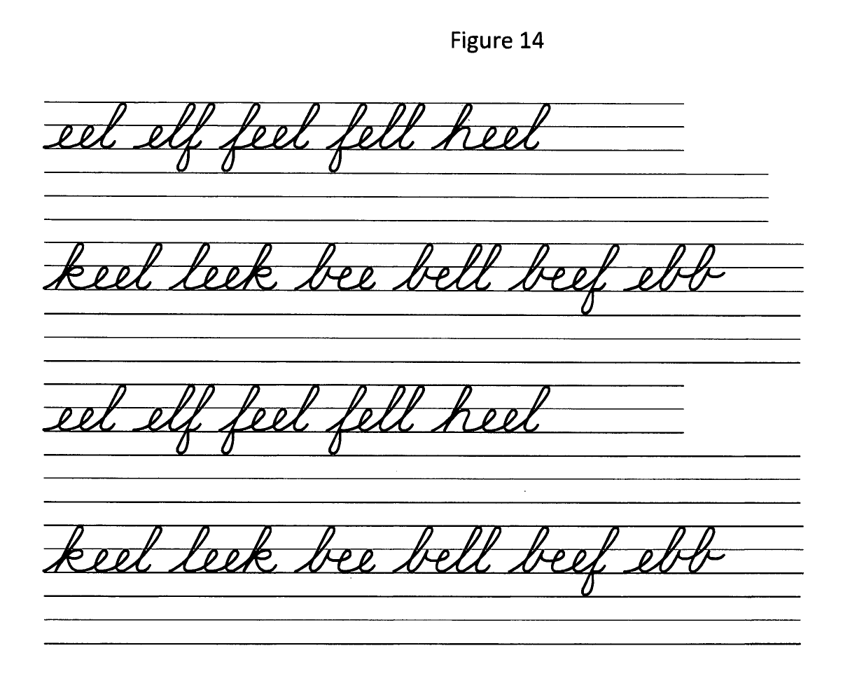

In FIG. 14, illustrated is a handwriting exercise consisting of words that can be formed using only the Loop letters.

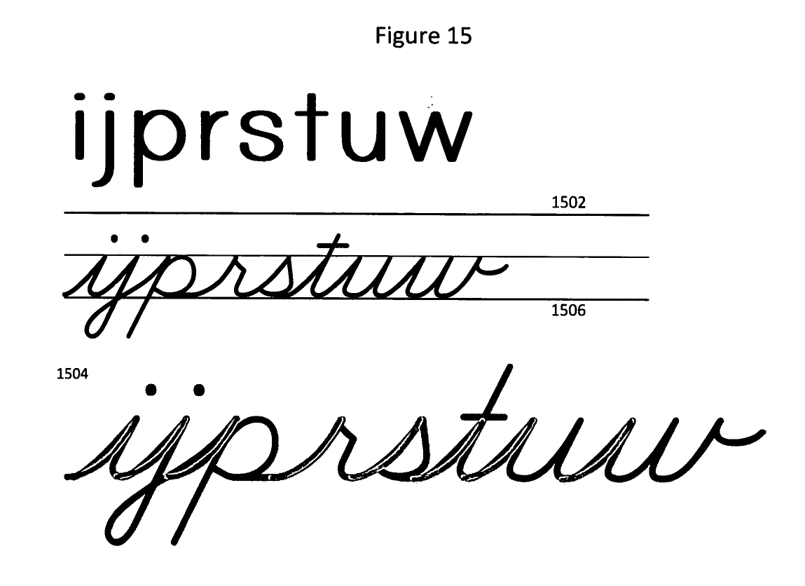

In FIG. 15, illustrated is one of the main exercises of the preferred embodiment of the invention which combines the Swing letters in a grouping. The grouping of the letters is designed to be the preferred embodiment where all the letters can be made in a single stroke without lifting the pen or electronic writing instrument. Item 1504 illustrates the portion of each letter that is not a swing in darker coloring and the portion of each letter that is a swing in lighter coloring.

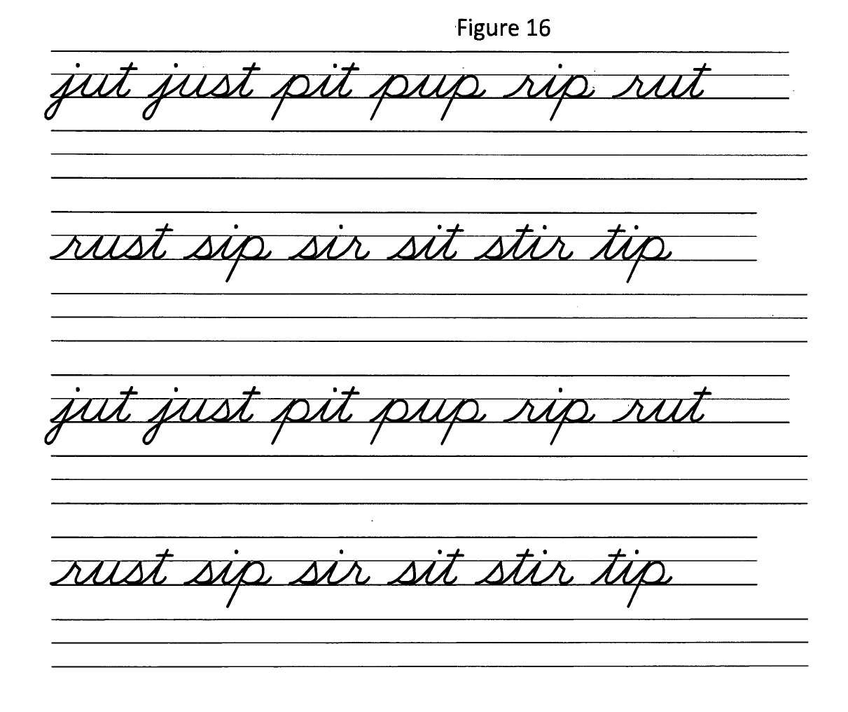

In FIG. 16, illustrated is a handwriting exercise consisting of words that can be formed using only the Swing letters.

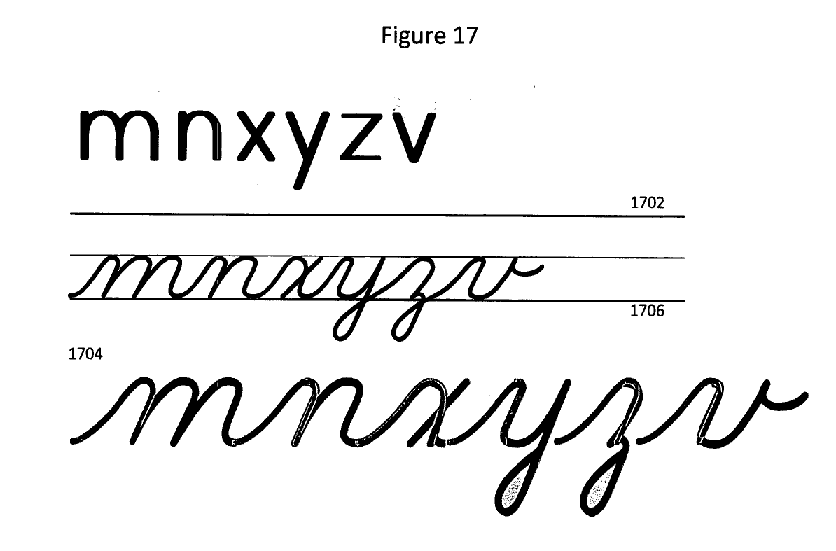

In FIG. 17, illustrated is one of the main exercises of the preferred embodiment of the invention which combines the mound letters in a grouping. The grouping of the letters is designed to be the preferred embodiment where all the letters can be made in a single stroke without lifting the pen or electronic writing instrument. Item 1704 illustrates the portion of each letter that is not a mound in darker coloring and the portion of each letter that is a mound in lighter coloring.

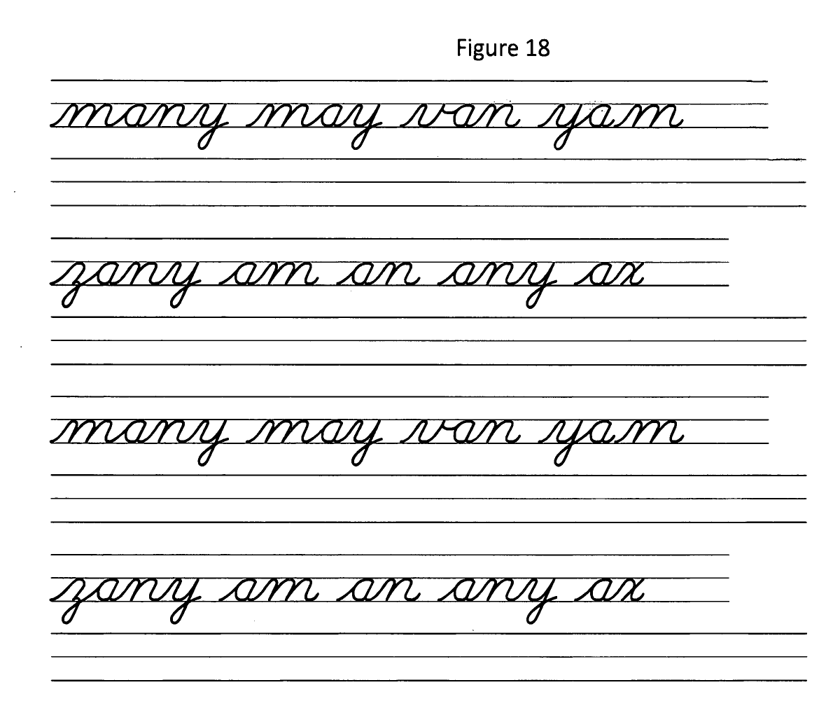

In FIG. 18, illustrated is a handwriting exercise consisting of words that can be formed using only the Mound letters.

The teachings disclosed in this application may be carried out in a variety of means which are readily available to those of ordinary skill in the art of handwriting instruction and handwriting recognition on electronic devices. Computing devices, tablets, smart phones, touch screens, simulated writing instruments, touchpads, chalk boards, textbooks, and other devices capable of receiving or displaying handwritten cursive letters may be used to implement these teachings. For the purposes of this invention, any computer-readable medium shall be considered non-transitory, so as to exclude signals, carrier waves, and the like.

1. A method for minimizing the time required to teach cursive handwriting to a student comprising a lesson which groups the 26 lower-case letters of the English alphabet into four groups of letters where the letters are grouped according to a primary stroke required to create each of the letters in said grouping.

2. The method of claim 1, wherein the primary stroke is the first stroke in the creation of the cursive letter, and wherein the stroke represents an oval, a loop, a swing, or a mound.

3. The method of claim 2 wherein an oval comprises written stroke as follows: from the baseline, curve up to the midline, over right and below the midline in an oval shape; stroke back around the oval shape to the baseline.

4. The method of claim 3 wherein the primary stroke is an oval and the letters in the grouping are ‘a,’ ‘c,’ ‘d,’ ‘g,’ ‘q,’ and ‘o.’

5. The method of claim 4 wherein the lesson includes a single stroke creating the lower-case cursive letters “acdgqo” in this exact order.

6. The method of claim 2 wherein a loop comprises a written stroke as follows:
from baseline slant up and right to top line; loop left and down stroke closing the loop.

7. The method of claim 6 wherein the primary stroke is a loop and the letters are ‘f,’ ‘h,’ ‘k,’ ‘l,’ ‘e,’ and ‘b.’

8. The method of claim 7 wherein the lesson includes a single continuous movement creating the lower-case cursive letters “fhkleb” in this exact order.

9. The method of claim 2 wherein a swing comprises a written stroke as follows:
from baseline swing right and up to the midline.

10. The method of claim 9 wherein the primary stroke is an swing and the letters are ‘j,’ ‘p,’ ‘r,’ ‘s,’ ‘t,’ ‘u, ’ and ‘w.’

11. The method of claim 10 wherein the lesson includes a continuous movement creating the lower-case cursive letters “jprstuw” in this exact order.

12. The method of claim 2 wherein a mound comprises a written stroke as follows:
from baseline slant up to touch the midline and curve down again to the baseline.

13. The method of claim 12 wherein the primary stroke is a mound and the letters are ‘m,’ ‘n,’ ‘x,’ ‘y,’ ‘z’, and ‘v.’

14. The method of claim 3 wherein the lesson includes a continuous movement creating the lower-case letters “mnxyzv” in this exact order.
